(19) United States
(12) Patent Application Publication
(10) Pub. No.: US 2026/0270320 A1
(43) Pub. Date: Sep. 10, 2026

(54) EXTERNAL DEVICE CONTROL BASED ON CONNECTED NETWORK

(71) Applicant: Hewlett-Packard Development Company, L.P., Spring, TX (US)

(72) Inventors: Sohye KIM, Seongnam Si (KR); Junyoung CHOI, Seongnam Si (KR); Sangmin LEE, Seongnam Si (KR); Mikyung CHOI, Seongnam Si (KR); Deokhee BOO, Seongnam Si (KR)

(21) Appl. No.: 18/871,876

(22) PCT Filed: Dec. 8, 2022
(86) PCT No.: PCT/US2022/052221

§ 371 Date: Dec. 5, 2024

(30) Foreign Application Priority Data
Jun. 9, 2022 (KR) 10-2022-0070158

(51) Int. Cl. H04L 67/00; H04L 67/306

(52) U.S. Cl. CPC H04L 67/34; H04L 67/306

(57) ABSTRACT

An example method for external device control includes identifying whether a network to which an electronic device is connected is a first network, in response to identifying that the network to which the electronic device is connected is the first network, converting a user account that is used in an application to a converted user account that corresponds to the first network, the application being installed in the electronic device, and, in response to the conversion, updating an operational configuration of an external device to an operational configuration that corresponds to the converted user account, the external device being under control through the application.

### BACKGROUND

A user's electronic device may be controlled and used while being in wireless or wired communicative connection with an external device. Examples of the external device include a text entry device, an optical input device, an on-screen input device, an image output device, an audio output device, an image forming apparatus, and the like. Further, there exist many different types of image forming apparatuses, including dedicated printers, scanners, photocopiers, facsimile machines, etc., and also multi-function products (MFPs). An MFP acts as an all-in-one solution to provide a combination of, e.g., print, photocopy, scan, and fax functions.

Such image forming apparatus or other external device may be utilized with an application installed in the user's electronic device. For example, the user may have control over the external device through the application by generating his/her account for the application and registering the external device with the user account.

### BRIEF DESCRIPTION OF THE DRAWINGS

Various examples will be described below by referring to the following figures.

FIG. 1 is a diagram conceptually illustrating an electronic device in which a function of controlling an external device based on a connected network may be implemented according to an example.

FIG. 2 is a schematic diagram illustratively showing operations of an application installed in an electronic device according to an example.

FIG. 3 is a diagram illustratively showing a network identifier repository according to an example.

FIG. 4 is a flow diagram of operations of an electronic device updating information regarding an environmental configuration of an external device according to an example.

FIG. 5 is a diagram illustratively showing operations of an electronic device based on an account being logged out according to an example.

FIG. 6 is a diagram illustratively showing operations of an electronic device selecting, based on its connected network, a corresponding user account and automatically updating information regarding a configuration of an external device to one that corresponds to the account according to an example.

FIG. 7 is a diagram illustratively showing operations of identifying whether a network to which an electronic device is connected is a first network according to an example.

FIG. 8 is a diagram showing operations of configuring an application installed in an electronic device such that the application is used with a user account corresponding to the connected network according to an example.

FIG. 9 is a diagram schematically illustrating a list of login accounts of an application with multi-account login thereto being available according to an example.

FIG. 10 is a diagram showing an example in which the information regarding the configuration of the device is updated in accordance with organization information and policy information.

FIG. 11 is a flow diagram illustrating a method for external device control based on a connected network according to an example.

FIG. 12 is a schematic illustration of a non-transitory computer readable recording medium including instructions for causing operations to be performed according to an example.

### DETAILED DESCRIPTION

Hereinafter, various examples will be described with reference to the drawings. Like reference numerals in the specification and the drawings denote like elements, and thus a redundant description may be omitted.

A user's electronic device may have an application installed therein to control an external device that is connected to the electronic device. The application may retrieve information regarding an environmental configuration of the external device or information regarding another configuration of the external device, where such configuration information is associated with a user account for the application.

Further, the user may register a plurality of accounts on the application. The user may switch between the accounts that are currently available for the application, for example depending on a location of the user or an available network environment. While allowing the user to use a number of external devices, this conversion might involve changing the multi-account user's logged-in account in a manual manner.

Thus, in accordance with some examples of the present disclosure, a login account for an application may be automatically converted, without a user's manual intervention, to a suitable corresponding one depending on a network environment in which the user is situated. Further, in accordance with some examples of the present disclosure, an environmental configuration value of an external device that is under control through the application may be updated, without the user's manual intervention, to that associated with the corresponding login account.

In an example where the application is installed in the user's electronic device to control the external device with these devices being connected to each other, the electronic device may store information regarding a network to which it has previously been connected and may also store, in association, the user's login account that is used for the application on the network and an environmental configuration value of the external device. Based on detecting that there is a change of a network to which the electronic device is connected, the application may acquire login information regarding an account that corresponds to the changed network environment, configure the application to be used with the corresponding account, and automatically update an operational configuration of the external device to an operational configuration that corresponds to this account.

Various terms used in the present disclosure are chosen from a terminology of commonly used terms in consideration of their function herein, which may be appreciated differently depending on an intention of a user, a precedent case, or an emerging new technology. In specific instances, some terms are to be construed as set forth in the detailed description. Accordingly, the terms used herein are to be defined consistently with their meanings in the context of the present disclosure, rather than simply by their plain and ordinary meaning.

The terms “comprising,” “including,” “having,” “containing,” etc. are used herein to specify the presence of the elements listed thereafter. Unless otherwise indicated, these terms and variations thereof are not meant to exclude the presence or addition of other elements.

As used herein, the ordinal terms “first,” “second,” and so forth are meant to identify several similar elements. Unless otherwise specified, such terms are not intended to impose limitations, e.g., a particular order of these elements or of their use, but rather are used merely for referring to multiple elements separately. For instance, an element may be referred to in an example with the term “first” while the same element may be referred to in another example with a different ordinal number such as “second” or “third.” In such examples, such ordinal terms are not to limit the scope of the present disclosure. Also, the use of the term “and/or” in a list of multiple elements is inclusive of all possible combinations of the listed items, including any one or plurality of the items.

The term “image forming job” as used herein may encompass any of a variety of image-related jobs that involve an operation of forming an image and/or other processing operations, e.g., creation, generation, and/or transfer of an image file. The term “job” as used herein may encompass a chain of processes that facilitate an image forming job, as well as the image forming job per se. By way of example and not limitation, an image forming device may perform an image forming job, such as a print job, a copy job, a scan job, a facsimile or other transmission job, a storage job, a coating job, or the like.

The term “image forming device” or “image forming apparatus” as used herein may encompass any of a variety of devices, such as a printer, a copier, a scanner, a facsimile machine, a multi-function product (MFP), a display device, and the like, that are capable of performing an image forming job. In some examples, an image forming device may be a two-dimensional (2D) or three-dimensional (3D) image forming device. Such image forming device may provide various additional functions, as well as basic ones, for example, print, copy, scan, and fax functions.

The term “user” as used herein may refer to a person/organization who manipulates an image forming device to operate an image forming job. The term “administrator” as used herein may refer to a person/organization who has access to the entire functionality of an image forming device. In some examples, one person may have both roles of an administrator and a user.

The terms “electronic device”, “electronic apparatus,” or “user device” as used herein may refer to any information processing device, such as, for example, a computer, a laptop, a tablet PC, a mobile telephone terminal, or the like, that may be used by a user.

The term “external device” may refer to a user device that is connectable with an electronic device in a wireless or wired manner. For example, an external device may include any of an image forming apparatus, a text entry device, an optical input device, an on-screen input device, an image output device, an audio output device, or other type of user device that can be connected with an electronic device.

The term “universal printer driver (UPD)” may refer to a driver that facilitates single-print-driver control and management of operations of a printer.

Examples of the present disclosure will now be described with reference to the accompanying drawings. The present disclosure may, however, have examples in many different forms and should not be construed as limited to the examples set forth herein. Rather, these examples are given in order to provide a better understanding of the scope of the present disclosure.

These and other features of the examples will become apparent from the following detailed description taken in conjunction with the accompanying drawings.

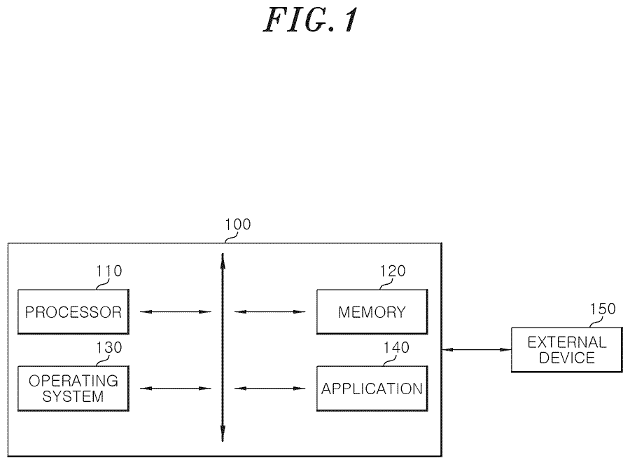

FIG. 1 is a diagram conceptually illustrating an electronic device in which a function of controlling an external device based on a connected network may be implemented according to an example.

As shown in FIG. 1, an electronic device 100 may include a processor 110, a memory 120, an operating system 130, and an application 140. Other configurations of the electronic device 100 are also contemplated. In an example, the electronic device 100 may also include an additional component, e.g., a power supply unit to supply power to the above-mentioned components, a user interface unit, a communications unit to communicatively couple to those components or external entities, or the like. In another example, the electronic device 100 may include some of, but not all of, the components shown in FIG. 1. Further, it may be appreciated that the electronic device 100 may be a single device or may include a plurality of interconnected devices.

In some examples, the processor 110 may control the overall functionality of the electronic device 100. For example, the processor 110 may be implemented with a central processing unit (CPU), a graphics processing unit (GPU), or other processing circuitry to perform the operations described herein. For example, the processor 110 may execute an instruction stored in the memory 120. The processor 110 may also read other information stored in the memory 120. In addition, the processor 110 may store new information in the memory 120 and may update information stored in the memory 120. For example, the processor 110 may obtain, from the memory 120, information used to control the electronic device 100 or may store such information in the memory 120.

In an example, if there occurs an event related to a network to which the electronic device 100 is connected, the electronic device 100, e.g., the processor 110 thereof, may receive the network event from the operating system 130. Such network event may be caused by a change of the network to which the electronic device 100 is connected, by a user starting up the electronic device 100 and logging in to the operating system 130, or by other circumstances. In response to receiving the network event, the processor 110 of the electronic device 100 may request and receive, from the operating system in control of a network device, an address, e.g., a gateway MAC address, on the network to which the electronic device 100 is currently connected.

The application 140 operates in conjunction with an external device connected with the electronic device 100, such as an external device 150, and is a component to control a function and an environmental configuration of the external device 150. The application 140 may provide a login function for a user account and, in particular, a multi-account login function of keeping a plurality of user accounts logged in thereto. Thus, the user may be logged in to the application 140 with the user's plurality of accounts. In this regard, after receiving the network event from the operating system 130, the application 140 may receive information regarding the network to which the electronic device 100 is currently connected and information regarding a user's account that is associated therewith. The application 140 may retrieve information regarding an environmental configuration of the external device being under control through the application or information regarding another configuration of the external device, where such configuration information is associated with the account.

In FIG. 1, the external device 150 is a user device that is connectable with the electronic device 100 in a wireless or wired manner. Examples of the external device 150 include an image forming apparatus, a text entry device, an optical input device, an on-screen input device, an image output device, an audio output device, and the like.

Referring to an example in which the external device 150 is an image forming apparatus, certain example configurations and operations will now be described.

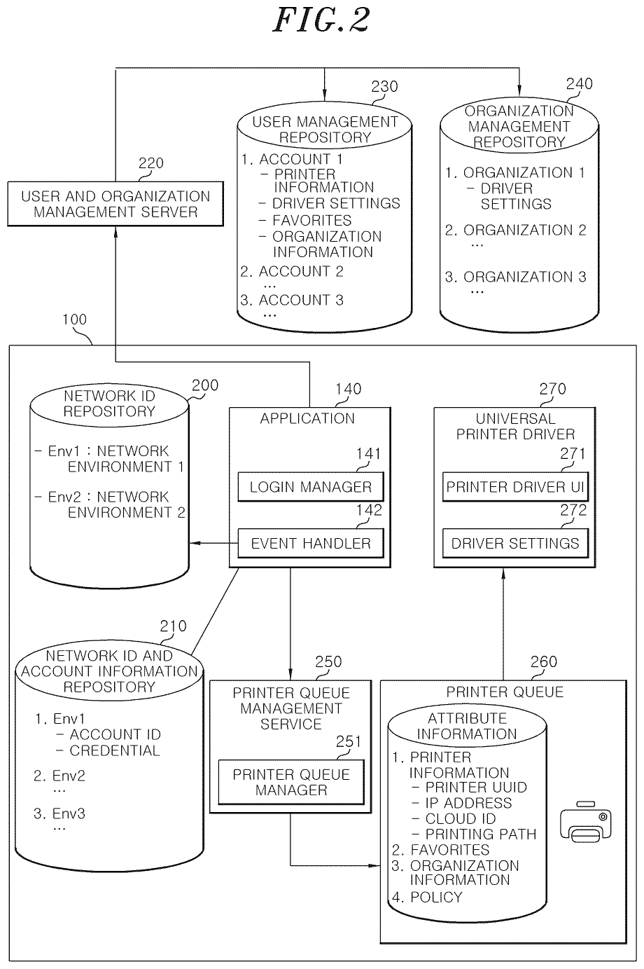

FIG. 2 is a schematic diagram illustratively showing operations of an application installed in an electronic device according to an example.

As discussed above, as the electronic device 100 is connectable with the external device 150, the application 140 may operate in conjunction with the external device 150 to, e.g., control the external device 150. In the example of FIG. 2, the external device 150 is illustrated as an image forming apparatus to be controlled by the application 140. The application 140 may be installed, together with a universal printer driver 270 and a printer queue 260, in the electronic device 100. Further, the application 140 may provide a login manager 141 and an event handler 142. It may be understood that the application 140 may include a module or a sub-application, including the login manager 141 and the event handler 142. Any of these modules may be implemented in hardware, machine readable instructions, or a combination thereof. It is also to be appreciated that the hardware/machine readable instructions/other modules may or may not be physically separate from one another and that various ones of the modules may be combined into a single or multiple units.

In some examples, the login manager 141 may perform the user login function. Based on the user logging in to the application with his/her user account, the login manager 141 may use information regarding the account, for example, an identifier (ID) of the account, to receive information regarding an operational configuration of the image forming apparatus, such as a resolution, a color/monochrome output mode, a printing paper size, and other configurations of the image forming apparatus, in relation to the user account. For example, the operational configuration information may be received from a user and organization management server 220. Further, if organization administrators manage their own respective group policies, the login manager 141 may receive information regarding a group policy to be applied to the user. The received operational configuration may be sent to a printer queue management service 250 which may include a printer queue manager 251 to apply the operational configuration to the printer queue 260, thereby operating the image forming apparatus based on the operational configuration.

In some examples, the application may be connected to a cloud server or other type of service server for providing its service. In an example where the server is connected with the application, the server may provide its particular service related to the external device 150. As such, the user account logged in to the application may be a cloud account or other type of user account registered with the server. In other examples, different implementations are possible.

In some examples, based on a particular event occurring in the electronic device 100, the event handler 142 may receive and process the event. For example, the particular event may include a network event. The network event may include a start-up of the electronic device 100 for a new connection to a network, a change of the network to which the electronic device 100 is connected, or the like. Based on such event occurring, the event handler 142 may identify that the user is placed into a new working environment and may store, among other things, information regarding a previous configuration, such as a network ID, an account ID, a credential, or the like, of the image forming apparatus, which is under management on the electronic device 100. For example, the current configuration information may be stored in a network identifier and account information repository 210. The event handler 142 may identify whether the changed network environment corresponds to a first network that fulfills a certain condition. As an example, as some network environments and their corresponding network identifiers may be stored in a network identifier repository 200, it may be identified whether the changed network environment corresponds to the first network. If it is identified that the changed network environment matches one of the network environments stored in the network identifier repository 200, the event handler 142 may acquire a network identifier that uniquely identifies the network environment, such as denoted in FIG. 2 as Env1, Env2, or the like. Thereafter, the login manager 141 may acquire, from the network identifier and account information repository 210, login information, such as an account ID, a credential, or the like, regarding a user account that corresponds to the acquired network identifier. For example, the user account that corresponds to the network identifier may be one that is specified for use in the network environment corresponding to the network identifier and is stored in correspondence with the network identifier. The network identifier and account information repository 210 may have stored therein network identifiers, such as Env1, Env2, etc., that uniquely identify network environments, respectively, and login information, such as account IDs, credentials, etc., regarding user accounts that correspond to the network identifiers, respectively. The login manager 141 may perform a login procedure for the application based on the acquired information.

In some examples, the first network may be a network to which the electronic device 100 has previously been connected. Other examples of the first network are also contemplated herein, including, e.g., a network that is previously identified by the user, the electronic device 100, the application, or the like, such as a network that is previously selected by the user or an administrator, a network that fulfills a particular condition, and so forth. Other examples are also contemplated in which an environment of a connected network may be uniquely identified and matched with login information that is configured for use in logging in to the application in the environment.

In some examples, the network identifier repository 200 may manage a list of networks, including the first network, as follows. In an example where an environment of a network to which the electronic device 100 is currently connected is uniquely identified by a network identifier, the event handler 142 of the application 140 may identify if the currently connected network of the electronic device 100 is the first network, which is included in the network list. Based on the identification, the event handler 142 may generate, for the network, a new network identifier for storage or may acquire the network identifier corresponding to the network.

In some examples, the network identifier and account information repository 210 may manage network identifiers stored in the network identifier repository 200 and login information, including, e.g., account IDs and credentials, regarding user accounts that respectively correspond to the network identifiers. In an example where a business account and no other account is available to the electronic device 100 based on the electronic device 100 connecting to a corporate network, it can be said that the corporate network and the business account are associated with each other. In this example, the network identifier repository 200 may have stored therein a network identifier of the corporate network. The event handler 142 of the application 140 may bring the network identifier into correspondence with login information regarding the business account to store, in the network identifier and account information repository 210, the network identifier and the login information. In a further example, based on receiving a network event upon occurrence of the network event, the event handler 142 may acquire, from the network identifier and account information repository 210, login information regarding an account that corresponds to an identifier of a network to which the electronic device 100 is currently connected and may deliver the acquired information to the login manager 141.

In some examples, logging in to a user account may require a credential, including, e.g., a password of the user account. The credential may be managed by the operating system 130 installed in the electronic device 100.

In some examples, based on the user logging in to the application 140, the user and organization management server 220 may read, from a user management repository 230 and an organization management repository 240, information regarding an operational configuration of the external device 150 that corresponds to his/her logged-in account, information regarding an organization to which the account belongs, information regarding a policy that is set for the organization, and the like.

The user management repository 230 may store, in association, each individual user account and information regarding an environmental configuration of the external device that corresponds to that user account. In an example where the external device is an image forming apparatus, the configuration information may include information regarding the image forming apparatus, information regarding driver settings thereof, information regarding user favorites thereof, or the like. Further, the user management repository 230 may have stored therein, in association with the first network, an organization to which the corresponding account belongs.

The organization management repository 240 may store associated information regarding each individual organization to which a corresponding user account belongs. For example, the organization information may include information regarding a policy for that organization. In an example where the external device is an image forming apparatus, the organization policy information may include a default value with which to configure a particular driver, an activation or deactivation of a particular configuration item, and the like.

In an example, the user and organization management server 220 may be a cloud server or other type of server that is connected with the application. In this example, the user management repository 230 and the organization management repository 240 may be retained in a device that is separate from the electronic device 100. Other examples of the user management repository 230 and the organization management repository 240 are also contemplated herein. For example, the user management repository 230 and the organization management repository 240 may be locally retained in the memory 120 of the electronic device 100 or retained in another repository that is accessible to the electronic device 100 without the user and organization management server 220.

In an example where the external device is an image forming apparatus, there may be provided additional components including the printer queue management service 250, the printer queue 260, and the universal printer driver 270. The printer queue management service 250 may apply, to the printer queue, some information received via the login manager 141, including the environmental configuration information regarding the image forming apparatus and the organization information. For example, the printer queue 260 may have stored therein attribute information, including the information, the user favorites information, the organization information, the policy information, and the like, in which values are configured for use by the universal printer driver 270. The printer queue 260 may be configured for signaling of an image forming job to the image forming apparatus and connected to the universal printer driver 270. In an example, the printer queue may have an attribute information repository for retaining information regarding the printer queue, such as the information regarding its destination printer, i.e., the image forming apparatus, the information regarding the user favorites, the information regarding the organization including the user, and the information regarding the policy applied to the organization. The universal printer driver 270 may serve as a single driver by which to control and manage operations of a printer.

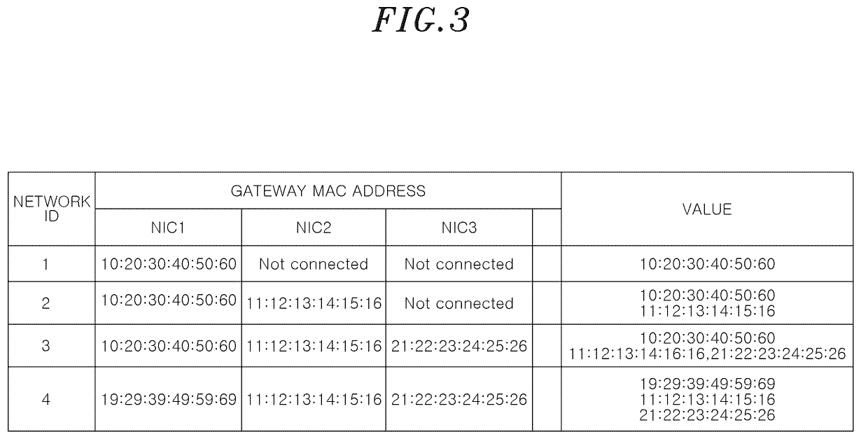

FIG. 3 is a diagram illustratively showing a network identifier repository according to an example.

In some examples, a network identifier may be an identifier that uniquely identifies an environment of a network to which the electronic device 100 is currently connected. The network identifier may be generated in association with an address of the connected network of the electronic device, such as a MAC address of a gateway of the network. The network identifier may be stored in the memory 120 of the electronic device 100 or a separate repository that is accessible to the electronic device 100. In an example, the electronic device 100 may be connected to one or a plurality of networks and have a network device, e.g., a network interface card (NIC), for each network connection. For example, the electronic device 100 may have two NICs, each of which supports connection to a wired network, and one NIC which supports connection to a wireless network. As the NICs are connected to their respective gateways, the MAC addresses of the gateways may be combined so as to uniquely generate a network identifier with its value. Thus, information regarding the environment of the network(s) to which the electronic device 100 is currently connected may be stored, in correspondence with the network identifier, in the network identifier repository 200. Further, it may be identified whether the first network is a currently connected network of the electronic device 100.

In the example of FIG. 3, the electronic device 100 has three NICs referred to as NIC1, NIC2, and NIC3. Network identifier 1 may be generated with a unique value of the MAC address of NIC1, e.g., 10:20:30:40:50:60, to identify an environment where NIC1 is connected to a certain network while neither NIC2 nor NIC3 is connected to any network. As such, network identifier 1 and the MAC address of NIC1 may be stored in association with each other. Network identifier 2 may be generated to identify an environment where NIC1 is connected to a certain network, NIC2 is connected to another network, and NIC3 is not connected to any network. Network identifier 3 is an example with which to identify an environment where NIC1, NIC2 and NIC3 are respectively connected to certain networks. Network identifier 4 is an example identifier that is generated to identify an environment where NIC1 is connected to a network other than those specified for network identifier 3. In this way, the electronic device 100 may acquire a list of networks including the first network, identify whether it is currently connected to the first network, and acquire a network identifier of the currently connected network. It is to be understood that other example ways of identifying whether the environment of the network(s) to which the electronic device 100 is connected corresponds to the first network are also possible.

With continued reference to an example where the external device 150 is an image forming apparatus, examples will be described below in which the electronic device operates based on a user logging in to or logging out of the application 140.

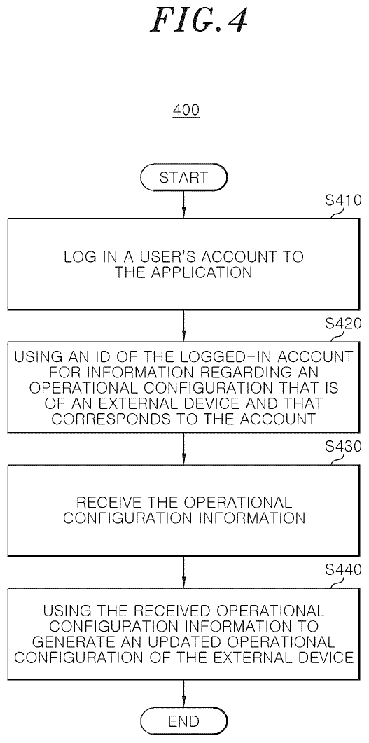

FIG. 4 is a flow diagram of operations of an electronic device updating information regarding an environmental configuration of an external device according to an example.

In the example of FIG. 4, a user's account is logged in to the application at operation S410.

At operation S420, an ID of the logged-in user account is used to make a request for an operational configuration of an external device such as the external device 150 and for its connected network corresponding to the account. In an example where the external device is an image forming apparatus which is used by the user with the account, the operational configuration of the image forming apparatus may include information regarding the image forming apparatus, information regarding driver settings thereof, information regarding favorites thereof, and information regarding an organization to which the account belongs. For example, the request for the operational configuration of the image forming apparatus may further include a request for the organization information. The organization information may also indicate a policy that is set for the organization, as well as the organization itself.

At operation S430, the operational configuration of the external device corresponding to the account is received.

At operation S440, the received operational configuration is used to generate an updated operational configuration of the external device. In an example where the external device is an image forming apparatus, the application 140 may deliver, to the printer queue management service 250, the operational configuration of the image forming apparatus and the like. The printer queue management service 250 may apply, to the printer queue, the configuration information, possibly with the organization information, received from the login manager 141, so as to generate the updated operational configuration of the image forming apparatus that corresponds to the account. Some of the received information may be applied for the information regarding attributes of the printer queue, the values of which may be used based on the printer driver creating an image forming job, signaling an image forming job to the image forming apparatus, or displaying a UI for setting the printer driver.

The above-mentioned operations may enable such updating by automatically retrieving an operational configuration of the external device 150 that has previously been used for the account. Therefore, the user may not need to manually change, on the electronic device, an operational configuration of the external device 150 connected thereto and may thus conveniently use the external device.

In addition to the image forming apparatus, other examples of the external device 150 are also contemplated including, e.g., a text entry device, an optical input device, an on-screen input device, an image output device, an audio output device, or other type of device that can be connected with the electronic device 100 so that its operational configuration may be controlled by the application. In such examples, the electronic device 100 may operate to receive, from a server, an operational configuration with which to use the external device 150 connected with the electronic device 100. Other example ways of updating an operational configuration of the external device 150 and applying the same to the electronic device 100 are also possible and contemplated herein.

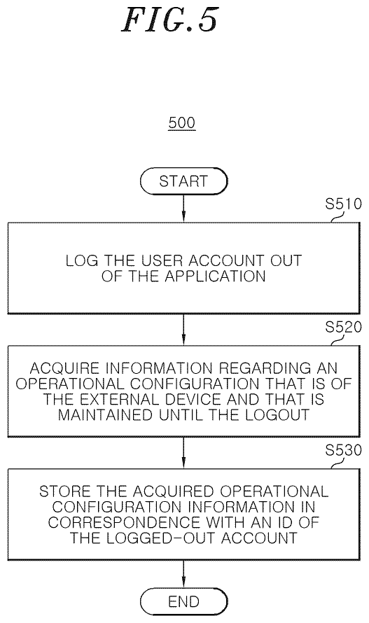

FIG. 5 is a diagram illustratively showing operations of an electronic device based on an account being logged out according to an example.

At operation S510, the account is logged out of the application. At operation S520, an operational configuration of the external device 150 that is maintained until the logout is acquired. In an example where the external device 150 is an image forming apparatus, the login manager 141 of the application 140 may acquire, from the printer queue manager 251, the operational configuration of the external device 150 that is maintained until the logout.

At operation S530, the acquired operational configuration is stored in correspondence with an ID of the logged-out account. For example, the acquired operational configuration, together with the ID of the logged-out account, may be sent to the user and organization management server 220, which may store, in correspondence, in the user management repository 230 and the organization management repository 240, the ID of the logged-out account and the operational configuration that is maintained until the logout.

Likewise, based on the application converting the currently used user account to another account, the above-mentioned operations may be performed. In an example where the user account that is used in the application for control of the electronic device 100 is converted to a converted user account that corresponds to the first network, the operational configuration of the external device 150 connected with the electronic device 100 may be stored, in correspondence with the user account, prior to the conversion.

The aforementioned process may enable storing, in the server or the like, the operational configuration of the image forming apparatus that is recently used by the user with the particular account.

The following describe examples of the electronic device 100 operating to automatically select a login account to update the device configuration.

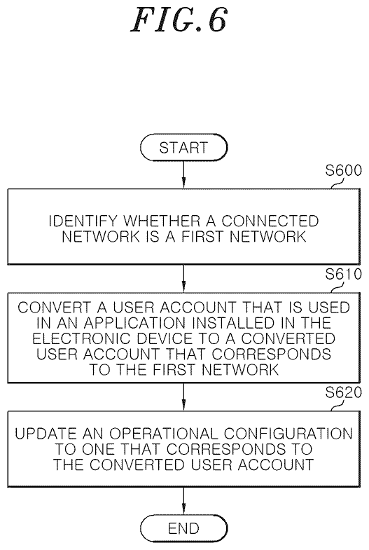

FIG. 6 is a diagram illustratively showing operations of an electronic device selecting, based on its connected network, a corresponding user account and automatically updating information regarding a configuration of an external device to one that corresponds to the account according to an example.

In an example, the electronic device 100 may perform the operations of FIG. 6 using a processor of the electronic device 100 or an application, module, or other machine readable instructions component implemented by the processor. Thus, these operations should be construed as able to be performed by the illustrated specific component of the example electronic device 100 as well as other components.

At operation S600, it is identified whether a network to which the electronic device is connected is a first network. In some examples, the first network may be a network to which the electronic device has previously been connected. Other examples of the first network are also contemplated herein, including, e.g., a network that is previously identified by a user, the electronic device, its installed application, or the like, such as a network that is previously selected by the user, a network that fulfills a particular predetermined condition, and so forth. Other examples are also contemplated in which an environment of a connected network may be uniquely identified and matched with login information that is configured for use in logging in to the application in the environment.

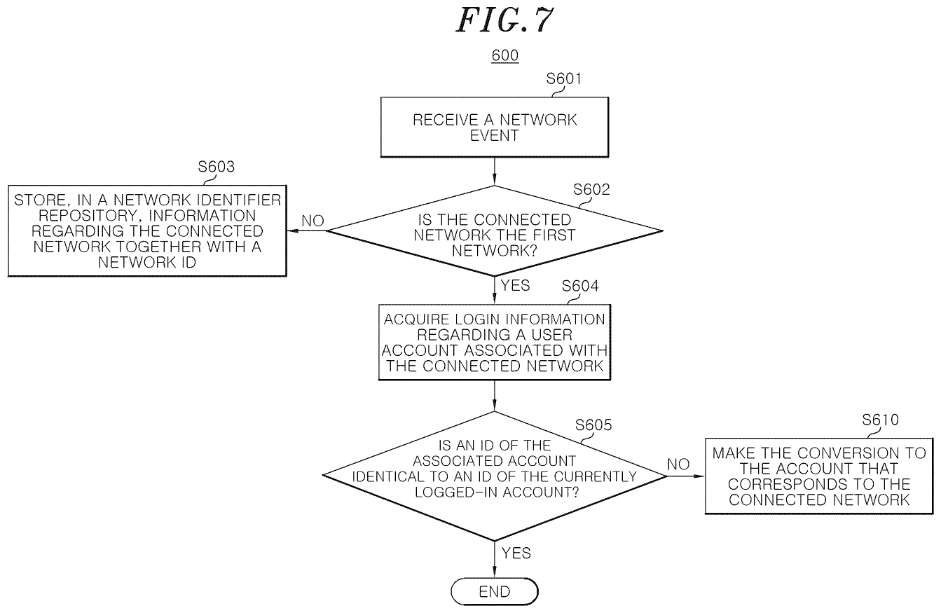

Example operations that may be performed if the first network is a network to which the electronic device has previously been connected are described with reference to FIG. 7 below.

FIG. 7 is a diagram illustratively showing operations of identifying whether the network to which an electronic device is connected is the first network according to an example.

At operation S601, a network event is received upon its occurrence in the electronic device. For example, the network event may include an event in which a network to which the electronic device 100 is connected is changed. In an example, the network related event that has occurred in the electronic device may be received from the operating system by the event handler of the application installed in the electronic device. Such network event may be caused by a change of the network to which the electronic device is connected, by the user starting up the electronic device and logging in to the operating system, or by other circumstances.

At operation S602, if the network event is received, it is identified whether the network to which the electronic device is connected is the first network.

This operation may include an operation of acquiring a network list in order to make the identification. In an example, the network list may include network identifiers, where each of the network identifiers corresponds to a network to which the electronic device has previously been connected. In this example, a network identifier of the first network may be one of the network identifiers included in the network list. In other words, the identification may include identifying whether the network to which the electronic device is currently connected is a network to which the electronic device has previously been connected. Other examples of the network included in the network list are also contemplated herein, including, e.g., a network that is previously identified by the user, the electronic device, the application, or the like, such as a network that is previously selected by the user or an administrator, a network that fulfills a particular condition, and so forth.

If it is identified at operation S602 that the network to which the electronic device is connected is not the first network, in other words, that the connected network is a new network to which the electronic device has not previously been connected, a new network identifier may be generated and stored in correspondence with the connected network at operation S603. Thus, the electronic device may store information regarding its initially connected network, thereby making a preparation so that, based on the electronic device being later re-connected to the network, automatic selection of a login account and automatic update of an operational configuration of the external device may be performed. With the electronic device being connected to the network to which it has not previously been connected, there is not any account that has previously been used with the new network. Therefore, this operation is terminated without changing the login account and the operational configuration.

In an example, based on the electronic device being connected to the network to which it has not previously been connected and the user's account being logged in to the application on the new network, login information regarding the account may be paired with the network identifier of the new network. Further, such pairing may be stored in the network identifier and account information repository.

Other examples of identifying, at operation S602, whether the network to which the electronic device is currently connected is the first network are also contemplated. For example, such identification may be made on a periodic basis or whenever the installed application is executed on the electronic device, rather than based on the network event being received at operation S601.

In an example, the network list may include a pairing of each of the network identifiers that corresponds to a respective network to which the electronic device has previously been connected and the login information regarding the user account that corresponds to the respective network. For example, the user account that corresponds to the network may be one that is specified for use in the network and may be thus stored in correspondence with the network identifier of the network. As discussed above, the login information regarding the user account may include an account ID and a credential. The credential may be used, together with the ID of the user account, for logging in the account. For example, the credential may be a password or the like. Accordingly, if the electronic device is connected to a network whose identifier corresponds to one of the network identifiers included in the network list, the login information regarding the user account that corresponds to the network may be acquired at operation S604. The login information regarding the account may be used in converting the user account that is used in the application installed in the electronic device to the user account that corresponds to the first network, i.e., the account specified for use in the first network.

In an example, the application may be connected to a cloud server or other type of server. In this regard, the user account logged in to the application may be a cloud account or other type of user account registered with the server that is connected with the application to provide a particular service related to the external device. In other examples, different implementations are possible.

In an example where the login information regarding the account that is currently being used in the application is acquired as above, it may be identified, based on the acquired login information, whether an ID of the currently used account is identical to that of the user account that corresponds to the connected network at operation S605. As an example, the user's account may be referred to as being currently used in the application in a situation in which the user is using the application on his/her laptop, i.e., the electronic device, at his/her office after logging in from home to the application on the laptop and then moving to the office without logging out of the application, or in which the connected network is changed while multiple accounts are kept logged in to the application. If it is identified that both IDs are identical to each other, the account that is currently being used in the application may be identical to that corresponding to the current network, i.e., the account that is used on the currently connected network. This operation may be terminated without changing the login account and the operational configuration. If it is identified that both IDs are not identical, the account that is currently being used in the application may not be that corresponding to the current network. Accordingly, operation S610 may be performed, at which the conversion is made so that the application may be used with the account that corresponds to the current network.

In some examples, operation S605 may be omitted based on the user starting the electronic device and there not being any account that is already logged in to the application. Instead, the account associated with the connected network may be directly set for use in the application. In other examples, different implementations are possible.

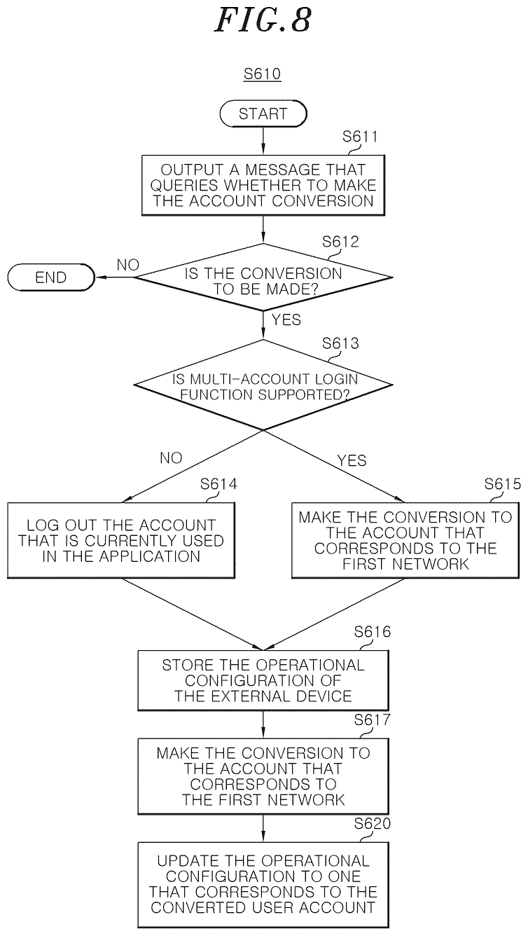

Turning back to FIG. 6, if the network to which the electronic device is connected is the first network, the account that is used in the application installed in the electronic device is converted to the user account that corresponds to the first network, i.e., the account that is specified for use in the first network at operation S610. Example operations of the conversion will be described below with reference to FIG. 8.

FIG. 8 is a diagram showing operations of configuring an application installed in an electronic device such that the application is used with a user account corresponding to the connected network according to an example.

In an example where operation S610 is performed with the identification that the ID of the account that is currently being used in the application for logging in thereto is different from that of the account that is specified for use in the first network, a message may be outputted that queries whether to make the conversion to the user account that corresponds to the first network at operation S611. At operation S612, a response to the message may be received. If a response is received indicating that the conversion is not to be made, the operation process of FIG. 8 is terminated without changing the account that is used in the application. If a response is received indicating that the conversion is to be made, the account that is used in the application is converted to that corresponding to the first network, as described below.

In some examples, operations S611 and S612 may be omitted. In other words, the user account conversion may be performed without outputting the message and receiving the response thereto. For example, based on there not being any account that is currently used in the application or with the application supporting multi-account login, the account associated with the network to which the electronic device is connected is not logged in, operations S611 and S612 may be omitted. In other examples, different implementations are possible.

Prior to the user account conversion, it may be identified whether the application installed in the electronic device supports a multi-account login function at operation S613. The term “multi-account login function” refers to a function of allowing a user to simultaneously use a plurality of accounts for logging in to one application. The plurality of accounts of the user may be kept simultaneously logged in to the application. That is, the application may use the plurality of accounts in a manner of converting from one of the accounts to another without an additional logout/login procedure.

If it is identified that the application does not support a multi-account login function, the account that is currently being used for the application is logged out at operation S614. In an example, the currently used account may be logged out so that the account specified for use in the first network, i.e., the network to which the electronic device is connected, may be logged in. If it is identified that the application supports a multi-account login function, the account that is currently being used in the application is converted to the user account that corresponds to the first network at operation S615.

In some examples, if the application supports a multi-account login function, but the user account corresponding to the first network is not logged in to the application, such login may be requested. In other examples, different implementations are possible. After the login, some operations such as those shown in the operations collectively denoted as 400 may be performed for updating information regarding an environmental configuration of the external device.

At operation S616, in response to the currently used account being logged out or converted, the information regarding the operational configuration of the external device, which operational configuration is set prior to the conversion, is stored in correspondence with the user account, which is used in the application prior to the conversion. In an example, operation S616 may be performed as illustrated with respect to the operations collectively denoted as 500.

After the account logged in to the application is logged out and the information regarding the current configuration of the image forming apparatus is stored together with the ID of the account, the account that is used in the application is converted to the account that corresponds to the first network at operation S617. That is, based on the account associated with the currently connected network being logged in to the application, or based on the application providing a multi-account login function, the conversion to the account that corresponds to the currently connected network may be made.

In an example where the application supports a multi-account login function, operation S617 of converting the account that is used in the application to the account that corresponds to the first network may include an operation of, if there exists, among the user's plurality of accounts logged in to the application, the user account that corresponds to the first network, configuring the application to be used with the user account that corresponds to the first network. That is, after the account that corresponds to the first network is retrieved from the plurality of simultaneously logged-in accounts, the conversion is made such that the application is used with the corresponding account.

Subsequent to operation S617, the operational configuration of the external device connected with the electronic device may be updated, at operation S620, to an operational configuration of the external device that corresponds to the converted user account. In an example where the external device is an image forming apparatus, an operational configuration of a driver installed therefor in the electronic device may be updated. In an example, the operation of the electronic device updating the operational configuration of the external device may be performed as illustrated with respect to the operations collectively denoted as 400.

In the above-mentioned examples, the external device is an image forming apparatus. However, other examples of the external device are also contemplated herein, including a text entry device, an optical input device, an on-screen input device, an image output device, an audio output device, or other type of user device that can be connected with the electronic device. Further, it should be understood that several suitable variations of the examples are applicable to a certain environment in which the application is installed to control the external device connected with the electronic device.

The above-discussed operations of automatically selecting a login account and updating a device configuration may help the user in reducing inconvenience of manually changing the login account according to a change of the network environment and may also enable storing and restoring a basic configuration specific to the user's desired account and to the network environment, thereby delivering user convenience. For example, as the user uses his/her laptop at his/her office and then at his/her home, the aforementioned operations may involve configuring the application to be used with a business account for use in a corporate network within the office and then with a personal account for use in a network within the home. Further, the configuration information regarding the image forming apparatus that the user has most recently used may be stored, in a server or the like, in association to the business account that is used on the corporate network. If a subsequent network event occurs in which a new connection is established to the corporate network, for example, if the following day the user goes to the office and uses the laptop, the stored information may be used for configuring the application to be used with the business account associated with the corporate network and may enable automatic update to the information regarding the configuration of the image forming apparatus that was used at the office the day before.

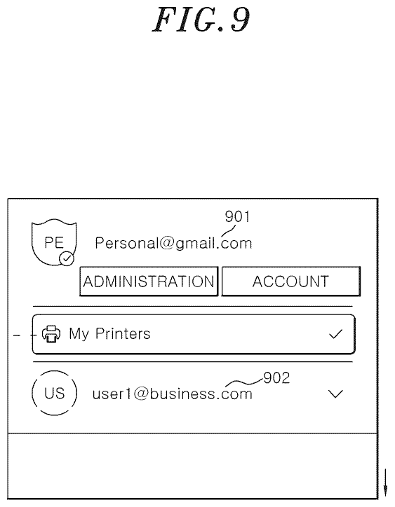

FIG. 9 is a diagram schematically illustrating a list of login accounts of an application with multi-account login thereto being available according to an example.

As mentioned above, the term “multi-account login function” refers to a function of allowing a user to simultaneously use multiple accounts for logging in to one application. As shown in FIG. 9, a personal account 901 indicated as “personal@gmail.com” is currently used in the application. Further, while a business account 902 indicated as “user1@business.com” is not currently used in the application, the accounts 901 and 902 remain simultaneously logged in to the application. In some examples, based on the electronic device having the application installed therein being connected to a network associated with the business account 902, the account that is used in the application may be converted to the business account 902. For example, the user may use the personal account 901 as a user account of the application based on the user utilizing the electronic device for his/her personal use at his/her home. Likewise, the account for use in the application may be converted to the business account 902 based on the user taking the electronic device to his/her office and using the application at the office.

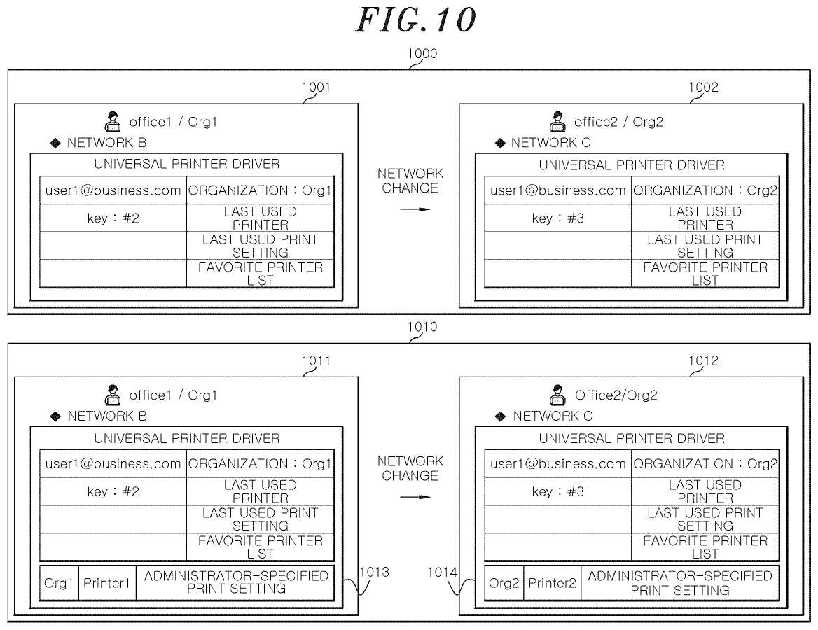

FIG. 10 is a diagram showing an example in which the information regarding the configuration of the device is updated in accordance with organization information and policy information.

As discussed above, the information regarding the operational configuration of the external device corresponding to the user account that corresponds to the first network may include information regarding an organization to which the account belongs. Further, the organization information may include information regarding a policy that is applied to the organization. For example, the account used by the user at the office may be his/her business account, which may belong to two organizations Org1 and Org2. The Org1 and Org2 organizations are respectively located at Office1 and Office2 having their respective different network environments.

In some examples, the account may be converted or changed based on the occurrence of a network event, as discussed above with respect to FIGS. 4 to 8. In some other examples, in response to a network event, a conversion or change may be made between the organizations to which the account belongs, with the account staying logged in.

Referring to block 1000 at the upper portion of FIG. 10, in a situation in which the user moves from Office1 to Office2, the organization that is set for the logged-in account is changed from Org1 to Org2, as indicated in blocks 1001 and 1002, respectively. For example, each of Office1 and Office2 may have a different image forming apparatus, which may thus have a different operational configuration, as well as a different network. If the user moves from Office1 to Office2, there occurs a network event in which a change is made from Network B to Network C. In this regard, the account specified for use in Office1 may be identical to that for Office2. In such case, the account that is used in the application may remain unconverted. Further, as discussed above, these two separate offices, Office1 and Office2, may have their respective different image forming apparatuses, the operational configurations of which may be different from each other. Thus, based on the occurrence of a network event and the organization that is set for the account logged in on the currently connected network changing from Org1 to Org2, the operational configuration of the image forming apparatus associated with the organization may be updated accordingly.

Referring to block 1010 at the lower portion of FIG. 10, in a situation in which, based on the occurrence of a network event, the organization that is set for the logged-in account is changed from Org1 to Org2, as indicated in blocks 1011 and 1012, respectively, the information regarding each of the organizations may include information 1013 or 1014 regarding a policy specified by an administrator. Accordingly, updating the operational configuration of the image forming apparatus may involve updating the policy information. For example, the policy information 1013 may be set by the administrator to impose upon Org1 a restriction that printing be performed in grayscale. Further, the information 1014 may be set by the administrator to impose upon Org2 a restriction that double-sided printing be performed rather than one-sided printing. The operational configuration of the image forming apparatus, including such policy information, may be updated based on occurrence of a network event, followed by a change of the organization to which the logged-in account belongs.

Examples of controlling the external device based on a connected network will now be described.

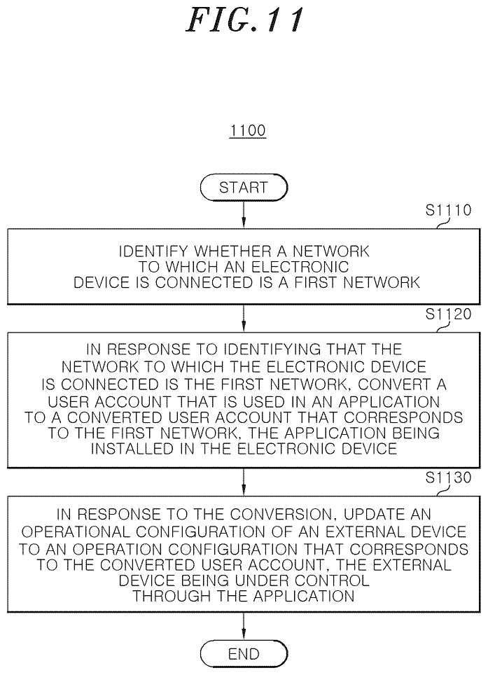

FIG. 11 is a flow diagram illustrating a method for external device control based on a connected network according to an example.

In an example, a method 1100 for external device control based on a connected network may be performed by an electronic device in which an application is installed to control an external device connected with the electronic device.

The method 1100 includes identifying whether a network to which an electronic device is connected is a first network at operation S1110. In response to identifying that the network to which the electronic device is connected is the first network, a user account that is used in an application is converted to a converted user account that corresponds to the first network at operation S1120, the application being installed in the electronic device. In response to the conversion, an operational configuration of an external device is updated to an operational configuration that corresponds to the converted user account at operation S1130, the external device being under control through the application.

Examples of operation S1110 will be provided. The identification made at S1110 as to whether the network to which the electronic device is connected is the first network may include an operation of acquiring a list of networks. In an example, the network list may include network identifiers, where each of the network identifiers corresponds to a network to which the electronic device has previously been connected. Further, in this example, one of the network identifiers included in the network list may be a network identifier of the first network. In other words, the identification may include identifying whether the network to which the electronic device is currently connected is a network to which the electronic device has previously been connected. Other examples of the networks included in the network list are also contemplated herein, including, e.g., a network that is previously identified by a user, the electronic device, the application, or the like, such as a network that is previously selected by the user or an administrator, a network that fulfills a particular condition, and so forth. Other examples are also contemplated in which an environment of a connected network may be uniquely identified and matched with login information that is configured for use in logging in to the application in the environment.

In an example, the network list may include a pairing of each of the network identifiers with login information regarding a user account that corresponds to a respective one of the networks. For example, the user account corresponding to the network may be one that is specified for use in the network. Accordingly, based on the network identifier of the network to which the electronic device is connected corresponding to one of the network identifiers included in the network list, the login information regarding the user account that corresponds to the network may be acquired. The information may be used to convert the account that is used in the application installed in the electronic device to the account that corresponds to the first network.

Examples of operation S1120 will be provided.

The conversion may be made based on identifying that the network to which the electronic device is connected is the first network. A message may be outputted that queries whether to make the conversion to the user account that corresponds to the first network. Further, a response to the message may be received. If a response is received indicating that the conversion is not to be made, the method of FIG. 11 is terminated without changing the account that is used in the application. If a response is received indicating that the conversion is to be made, the account that is used in the application is converted to that corresponding to the first network.

In some examples, the above-mentioned query and response may be omitted. In other words, the user account conversion may be performed without outputting the message and receiving the response thereto.

Prior to the user account conversion, it may be identified whether the application installed in the electronic device supports a multi-account login function. As mentioned above, the term “multi-account login function” refers to a function of allowing a user to simultaneously use multiple accounts for logging in to one application. The plurality of accounts of the user may be kept simultaneously logged in to the application. That is, the application may use the plurality of accounts in a manner of converting from one of the accounts to another without an additional logout/login procedure.

If it is identified that the application does not support a multi-account login function, the account that is currently being used for the application is logged out. In particular, the currently used account may be logged out so that the account specified for use in the first network, i.e., the network to which the electronic device is connected, may be logged in. If it is identified that the application supports a multi-account login function, the account that is currently being used in the application is converted to the user account that corresponds to the first network.

Further, based on the currently used account being converted or logged out, the operational configuration of the external device that is set prior to the conversion may be stored, in correspondence with the user account, which is used in the application prior to the conversion. Such operation may be performed as illustrated with respect to the operations collectively denoted as 500.

After the account logged in to the application is logged out and the information regarding the current operational configuration of the external device is stored together with the ID of the account, the account that is used in the application is converted to the account that corresponds to the first network at operation S1120. That is, based on the account that corresponds to the currently connected network being logged in to the application, or based on the application providing a multi-account login function, the conversion to the account that corresponds to the currently connected network may be made.

As discussed above, the network list may include a pairing of the network identifier of the first network with the login information regarding the user account that corresponds to the first network. Therefore, operation S1120 of converting the account that is used in the application installed in the electronic device to the user account that corresponds to the first network may be made using the login information included in the network list.

In an example where the application supports a multi-account login function, operation S1120 of converting the account that is used in the application to the account that corresponds to the first network may include an operation of, if there exists, among a plurality of accounts logged in to the application, the user account that corresponds to the first network, configuring the application to be used with the user account that corresponds to the first network. That is, after the account that corresponds to the first network is retrieved from the plurality of simultaneously logged-in accounts, the conversion is made such that the application is used with the corresponding account.

At operation S1130, based on the account that is used in the application installed in the electronic device being converted to the user account that corresponds to the first network, the operational configuration of the external device that is connected with the electronic device and that is under control through the application may be updated to an operational configuration that corresponds to the converted user account. The operation 1130 may be implemented in a manner similar to that described with respect to the operations collectively denoted as 400.

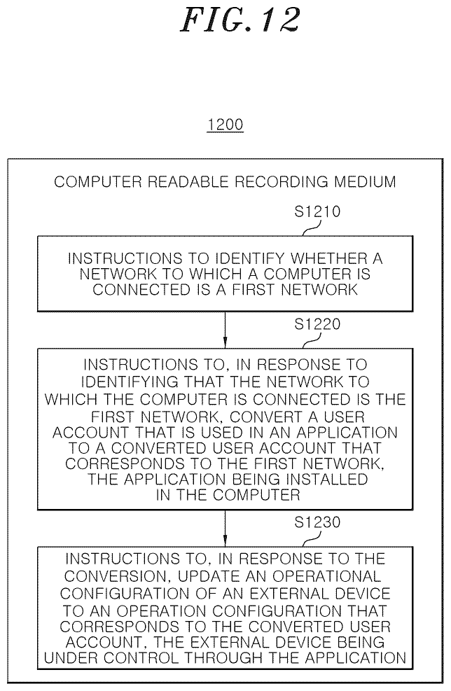

FIG. 12 is a schematic illustration of a non-transitory computer readable recording medium including instructions for causing operations to be performed according to an example.

As shown in FIG. 12, a non-transitory computer readable recording medium 1200 stores a computer program that is executable by a processor and programmable to implement some operations of the aforementioned example methodology, such as the operations of the electronic device described above with respect to FIGS. 1 to 10 and the operations of the method described above with respect to FIG. 11.

The computer program on the non-transitory computer readable recording medium 1200 may include a set of program instructions that direct the processor to perform specific operations. With reference to FIG. 12, an example of the computer program stored in the non-transitory computer readable recording medium 1200 will be described.

As shown in FIG. 12, the computer program includes instructions S1210 to identify whether a network to which an electronic device is connected is a first network, instructions S1220 to, in response to identifying that the network to which the electronic device is connected is the first network, convert a user account that is used in an application to a converted user account that corresponds to the first network, the application being installed in the electronic device, and instructions S1230 to, in response to the conversion, update an operational configuration of an external device to an operational configuration that corresponds to the converted user account, the external device being under control through the application.

As can be seen, upon execution of the computer program stored in the non-transitory computer readable recording medium 1200, the instructions S1210, S1220, and S1230 illustrated in FIG. 12, as well as the example operations described above with respect to FIGS. 1 to 10 and the example operations described above with respect to FIG. 11, may be performed by the computer, for example, the above-described electronic device.

The above-described computer readable recording medium may be a non-transitory readable medium. The term “non-transitory readable medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USB, a memory card, a ROM device, or any of other types of non-transitory readable media.

In a particular example, the example methodology disclosed herein may be incorporated into a computer program product. The computer program product may be available as a product for trading between a seller and a buyer. The computer program product may be distributed in the form of a machine-readable storage medium, e.g., compact disc read only memory (CD-ROM), or distributed online through an application store, e.g., PlayStore™. For the online distribution, at least a portion of the computer program product may be temporarily stored, or temporarily created, in a storage medium such as a server of the manufacturer, a server of the application store, or a storage medium such as memory of a relay server.

The foregoing description has been presented to illustrate and describe examples. It should be understood that many modifications and variations are possible in light of the above teaching. In various examples, suitable results may be achieved if the above-described techniques are performed in a different order, and/or if some of the components of the above-described systems, architectures, devices, circuits, and the like are coupled or combined in a different manner, or substituted for or replaced by other components or equivalents thereof.

Although the foregoing examples are described in the context of an image forming apparatus, it should be understood that the present disclosure is not limited to an image forming apparatus and is applicable in other situations where an application is installed to control an external device connected with an electronic device.

Therefore, the scope of the disclosure is not to be limited to the precise form disclosed, but rather defined by the following claims and equivalents thereof.

What is claimed is:

1. A method for external device control, the method comprising:
identifying whether a network to which an electronic device is connected is a first network;
in response to identifying that the network to which the electronic device is connected is the first network, converting a user account that is used in an application to a converted user account that corresponds to the first network, the application being installed in the electronic device; and
in response to the conversion, updating an operational configuration of an external device to an operational configuration that corresponds to the converted user account, the external device being under control through the application.

2. The method of claim 1, further comprising:
acquiring a network list comprising network identifiers,
wherein each of the network identifiers on the network list corresponds to a respective network to which the electronic device has previously been connected, and
wherein a network identifier of the first network corresponds to one of the network identifiers on the network list.

3. The method of claim 2,
wherein the network list comprises a pairing of each network identifier with login information regarding a respective user account that corresponds to the respective network, and
wherein the converting of the user account that is used in the application to the converted user account that corresponds to the first network comprises converting, by using the login information comprised in the network list, the user account that is used in the application to the converted user account that corresponds to the first network.

4. The method of claim 1, wherein, based on the application supporting a multi-account login function of keeping a plurality of accounts simultaneously logged in, the converting of the user account that is used in the application to the converted user account that corresponds to the first network comprises configuring the application to be used with the user account that corresponds to the first network if there exists, among a plurality of accounts logged in to the application, the user account that corresponds to the first network.

5. The method of claim 1, further comprising:
storing, prior to the conversion, the operational configuration of the external device in correspondence with the user account that is used in the application.

6. The method of claim 1, further comprising:
outputting a message that queries whether to make the conversion.

7. The method of claim 1, wherein the user account includes a cloud account or an account for a server connected with the application.

8. A non-transitory computer readable recording medium including instructions to cause a processor of an electronic device to perform operations for external device control, the non-transitory computer readable recording medium comprising:
instructions to identify whether a network to which the electronic device is connected is a first network;
instructions to, in response to identifying that the network to which the electronic device is connected is the first network, convert a user account that is used in an application to a converted user account that corresponds to the first network, the application being installed in the electronic device; and
instructions to, in response to the conversion, update an operational configuration of an external device to an operational configuration that corresponds to the converted user account, the external device being under control through the application.

9. The non-transitory computer readable recording medium of claim 8, further comprising:
instructions to acquire a network list comprising network identifiers,
wherein each of the network identifiers on the network list corresponds to a respective network to which the electronic device has previously been connected, and
wherein a network identifier of the first network corresponds to one of the network identifiers on the network list.

10. The non-transitory computer readable recording medium of claim 9,
wherein the network list comprises a pairing of each network identifier with login information regarding a respective user account that corresponds to the respective network, and
wherein the instructions to convert the user account that is used in the application to the converted user account that corresponds to the first network comprise instructions to convert, by using the login information comprised in the network list, the user account that is used in the application to the converted user account that corresponds to the first network.

11. The non-transitory computer readable recording medium of claim 8, wherein, based on the application supporting a multi-account login function of keeping a plurality of accounts simultaneously logged in, the instructions to convert the user account that is used in the application to the converted user account that corresponds to the first network comprise instructions to configure the application to be used with the user account that corresponds to the first network if there exists, among a plurality of accounts logged in to the application, the user account that corresponds to the first network.

12. The non-transitory computer readable recording medium of claim 8, further comprising:
instructions to store, prior to the conversion, in correspondence with the user account that is used in the application, the operational configuration of the external device.

13. The non-transitory computer readable recording medium of claim 8, further comprising:
instructions to output a message that queries whether to make the conversion.

14. An electronic device, comprising:
a memory to store instructions; and
a processor to execute the instructions to cause the processor to;
identify whether a network to which the electronic device is connected is a first network;
in response to identifying that the network to which the electronic device is connected is the first network, convert a user account that is used in an application to a converted user account that corresponds to the first network, the application being installed in the electronic device; and
in response to the conversion, update an operational configuration of an external device to an operational configuration that corresponds to the converted user account, the external device being under control through the application.

15. The electronic device of claim 14, wherein the instructions further cause the processor to:
acquire a network list comprising network identifiers,
wherein each of the network identifiers on the network list corresponds to a respective network to which the electronic device has previously been connected, and
wherein a network identifier of the first network corresponds to one of the network identifiers on the network list.
